(19) United States
(12) Patent Application Publication
(10) Pub. No.: US 2018/0103615 A1
(43) Pub. Date: Apr. 19, 2018

(54) Pet Toy Apparatus

(71) Applicant: Deborah Meade, Jonesville, VA (US)

(72) Inventor: Deborah Meade, Jonesville, VA (US)

(21) Appl. No.: 15/784,909

(22) Filed: Oct. 16, 2017

Related U.S. Application Data
(60) Provisional application No. 62/408,159, filed on Oct. 14, 2016.

(51) Int. Cl. A01K 15/02; B65H 75/40; B65H 75/48; B65H 75/44; F16G 11/10

(52) U.S. Cl. CPC A01K 15/025; B65H 75/40; F16G 11/10; B65H 75/4418; B65H 75/4402; B65H 75/486

(57) ABSTRACT

A pet toy apparatus is provided. The apparatus includes a housing having a bracket for mounting the apparatus onto a structure. A biased reel rotatably disposed in the housing includes an elongated tether wound thereabout. A quick release mechanism disposed on an end of the tether and positioned exterior to the housing is configured to interchangeably receive a pet toy. Rotation of the reel in a first direction winds and retracts the tether into the housing, while rotation of the reel in an opposing second direction unwinds and extends the tether out of the housing. The reel is biased in the first direction so as to tensionably rotate back in the first direction after being rotated in the second direction, thereby automatically retracting the tether. A stopper slidably disposed along the tether is configured to prevent retraction of the tether into the housing.

### CROSS REFERENCE TO RELATED APPLICATIONS

This application claims the benefit of U.S. Provisional Application No. 62/408,159 filed on Oct. 14, 2016. The above identified patent application is herein incorporated by reference in its entirety to provide continuity of disclosure.

### BACKGROUND OF THE INVENTION

The present invention relates to pet toys. More specifically, the present invention relates to a pet toy including an extendable and automatically retractable tether including a quick release mechanism for interchangeably receiving a toy.

Many pets, such as cats and dogs, are left alone during the day while their owners are at work or out doing their day-to-day activities, leaving pets without any interaction or attention. Left to their own devices, pets tend to cause mischief around a home, for example, chewing on various objects and batting toys under furniture. Moreover, if left without any interaction, pets may just sleep all day and get little to no exercise, causing them to gain weight and become sluggish over time.

Therefore, to remedy these problems it is known in the art to provide devices that are mountable onto home fixtures that include toys or tugs that are intended to be tugged on by a pet, particularly a dog. These devices include stationary toys which require interactive play between the dog and its owner or springs that provide resistance to the pulling action of the tug. However, such devices are not adjustable insofar as accounting for the size of the dog and include bulky housings intended to be affixed to a wall. Moreover, they provide no means for interchanging the toy and removing it for washing.

Therefore, there is a need in the art for a pet toy apparatus including an extendable and automatically retractable tether including a quick release mechanism for interchangeably receiving a toy.

### SUMMARY OF THE INVENTION

In view of the foregoing disadvantages inherent in the known types of pet toys now present in the prior art, the present invention provides a pet toy apparatus wherein the same can be utilized for providing convenience for a user when providing his or her pet a toy capable of interacting with the pet.

In one example of the present invention, the pet toy apparatus comprises a housing including an upper end, a lower end, a front side, a rear side, a sidewall interconnecting the first side to the second side, and an interior volume. A bracket extending radially outwardly from the upper end includes an opening for removably mounting the bracket onto a structure. A biased reel rotatably mounted within the interior volume is configured to rotate in a first direction and an opposing second direction. An elongated tether wound about the reel includes a first end affixed to the reel and a second end positioned exterior to the housing. The second end includes a quick release mechanism configured to removably receive a pet toy. The tether is configured to extend and retract from the housing. The reel is configured to wind and unwind the tether thereabout within the housing. Rotation of the reel in the first direction winds the tether around the biased reel and retracts the tether into the interior volume of the housing. Rotation of the biased reel in the second direction unwinds the tether from the biased reel and extends the tether out of the interior volume of the housing. The reel is biased in the first direction so as to have the tendency to automatically rotate back in the first direction after being rotated in the second direction and retract the tether into the housing. An aperture disposed on the lower end of the housing provides the tether a means for movement into and out of the interior volume of the housing. A stopper slidably disposed about a longitudinal length of the tether is positioned between the second end of the tether and the aperture of the housing. The stopper is configured to prevent retraction of the tether back into the housing, so as to adjust how much of the tether is positioned exterior to the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the pet toy apparatus according to one embodiment of the preset invention.

FIG. 2 shows a perspective phantom view of the pet toy apparatus according to one embodiment of the present invention.

FIG. 3 shows a perspective view of the pet toy apparatus in use according to one embodiment of the present invention.

### DETAILED DESCRIPTION OF THE INVENTION

Reference is made herein to the attached drawings. Like reference numerals are used throughout the drawings to depict like or similar elements of the pet toy apparatus. The figures are intended for representative purposes only and should not be considered to be limiting in any respect.

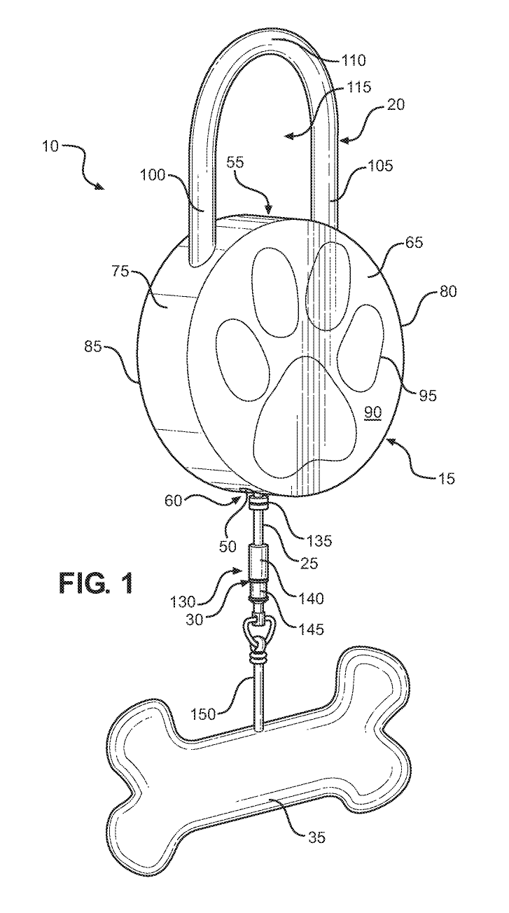

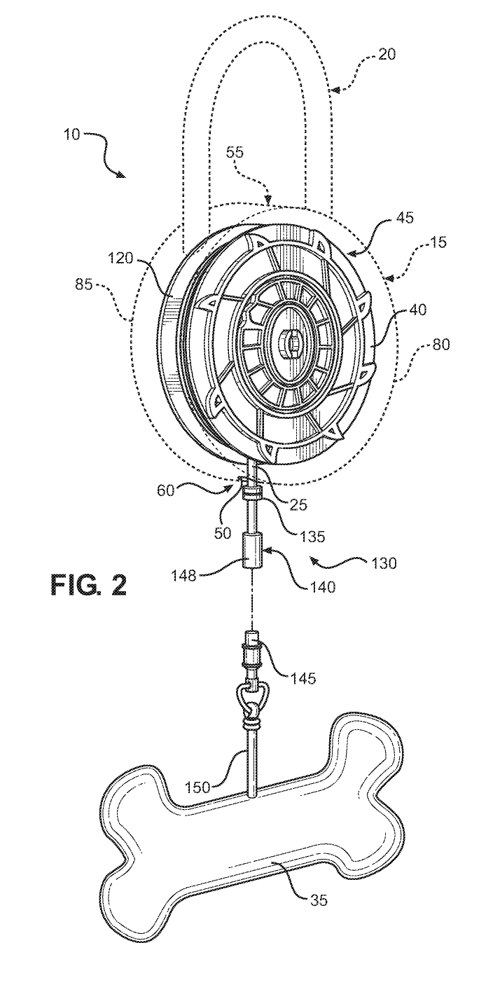

Referring now to FIGS. 1 and 2, there is shown a perspective view and a perspective phantom view of the pet toy apparatus, respectively. The present invention comprises a pet toy apparatus 10 including a housing 15 having a bracket 20 for mounting the pet toy apparatus 10 onto a structure, an elongated tether 25 extendable from the housing 15 including a quick release mechanism 30 for interchangeably receiving a pet toy 35, and a biased reel 40 configured to automatically retract the tether 25 when extended from the housing 15.

The housing 15 includes an upper end 55, a lower end 60, a front side 65, a rear side, a sidewall 75, an interior volume 45, and an aperture 50 for providing access to the interior volume 45. The front side 65 includes a front perimeter edge 80 and the rear side includes a rear perimeter edge 85. The front and rear perimeter edges 80, 85 are interconnected by the sidewall 75. In the depicted embodiment, the side wall is circular and includes a planar surface that extends annularly about the housing 15 between the front and rear perimeter edges 80, 85 of the housing 15. In the depicted embodiment, the aperture 50 is disposed on the sidewall 75 at the lower end 60 between the upper and lower perimeter edges 80, 85 of the housing 15. In one embodiment, the front side 65 includes a front surface 90 including indicia 95 for attracting or stimulating a pet animal to play with the pet toy apparatus 10.

The bracket 20 is disposed on the upper end 55 of the housing 15 and affixed to the sidewall 75. The bracket 20 protrudes vertically outwardly from the sidewall 75 and extends radially outwardly relative to the housing 15. In the depicted embodiment, the bracket 20 comprises a U-shaped member having a first end 100 and second end 105 affixed to a portion of the sidewall 75 that are interconnected by an arcuate portion 110. The first and second ends 100, 105 and the arcuate portion 110 define and opening 115 therebetween. The opening 115 is configured to receive various items such that a user may removably mount the housing 15 onto home fixtures and furniture, such as doorknobs, coat racks, handles, hooks, and the like.

The biased reel 40 is rotatably mounted within the interior volume 45 of the housing 15, such that the biased reel 40 is configured to rotate in a first direction and in an opposing second direction therein. In the depicted embodiment, the biased reel 40 is mounted in a center of the interior volume of the housing 15. Rotation of the biased reel 40 in the first direction winds the tether 25 about the biased reel 40, while rotation of the biased reel 40 in the second direction unwinds the tether 25 from the biased reel 40. The biased reel 40 includes a track 120 defining a groove configured to guide and receive the tether 25 when being extended or retracted, respectively, from the housing 15. The biased reel 40 is biased in the first direction such that when rotated in the second direction by an external force, the biased reel 40 develops a tension force opposing the second direction that provides the biased reel 40 the propensity to rotate in the first direction, thereby enabling the biased reel 40 to automatically rotate in the first direction when no external force is applied.

The tether 25 comprises an elongated flexible member, such as a rope or cord, wound around the biased reel 40. The tether 25 is in communication with the aperture 50, such that it may be extended and retracted through the aperture 50. The tether 25 includes a first end affixed to the biased reel 40 and a second end 130 positioned exterior to the aperture 50 and the interior volume 45 of the housing 15. The tether 25 includes a stopper 135 slidably disposed along the longitudinal length of tether 25. The stopper 135 is securable at any position along the length of the tether 25, such that its position along the tether 25 may be adjusted as desired. The stopper 135 extends annularly around the tether 25 and is positioned between the second end 130 of the tether 25 and the aperture 50 of the housing 15. The stopper 135 includes a diameter greater than a diameter of the aperture 50, such that the stopper 135 prevents entry of an exposed portion of the tether 25, which is disposed after the stopper 135, into the interior volume 45 of the housing 15. In this way, a user can adjust the stopper 135 along the length of the tether 25 so as to choose precisely how much of the tether 25 he or her she wants exposed, or positioned exterior to the housing 15, by halting the tether's retraction back into the housing 15. In the depicted embodiment, the stopper 135 comprises a rubber material for gripping the tether 25 and facilitating adjustment along the tether 25.

The quick release mechanism 30 is disposed on the second end 130 of the tether 25. The quick release mechanism 30 is configured to removably receive a pet toy 35, such that a user can interchange the pet toys disposed on pet toy apparatus 10 and remove the pet toys for washing or discarding. The quick release mechanism 30 includes a female portion 140, a male portion 145, and a biased collar 148 coupled to an aperture disposed on the female portion 140 that is configured to receive a pin 150 disposed the male portion 145. The biased collar 148 is configured to releasable engage the pin 150 when inserted into the female portion 140. The biased collar 148 extends annually around the female portion 140 and is slidably disposed along the length of the female portion 140. The biased collar 148 is biased towards a first position, in which the biased collar 148 engages the pin 150 when inserted into the aperture of the female portion 140. Longitudinal translation of the biased collar 148 towards the first end of the tether 25 releases the pin 150 from the aperture of the female portion 140, thereby allowing the pet toy 35 to be removed from the tether 25.

The pet toy 35 includes a second tether 150 extending therefrom that includes either the female or male portion 140, 145 of the quick release mechanism 30. In the depicted embodiment, the second end 130 includes the female portion 140 of the quick release mechanism 30 and the pet toy 35 includes the male portion 145 of the quick release mechanism 30. In one embodiment, the second end 130 includes the male portion 145 and the pet toy 35 includes the female portion 140. The pet toy 35 can include a dog toy, such as a rubber bone, a ball, and a plush stuffed animal, or a cat toy, such as a stuffed mouse, a cat teaser, and a jingle ball. In one embodiment of the present invention, the pet toy apparatus 10 comprises a plurality of pet toys each including either of the female or male portions 140, 145 of the quick release mechanism 30 for facilitating interchanging of the plurality of pet toys.

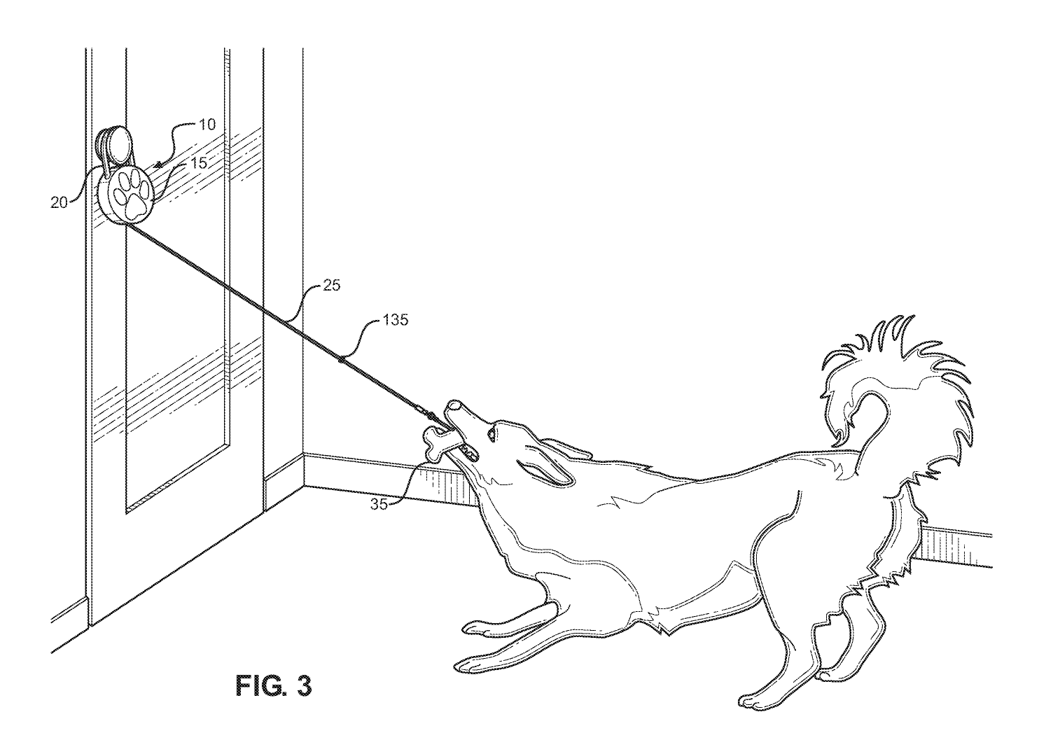

Referring now to FIG. 3, there is shown a perspective view of the pet toy apparatus in use. In one operation, a user mounts the bracket 20 onto a doorknob in order to suspend the pet toy apparatus 10 therefrom. The user then extends the tether 25 out of the housing 15 and adjusts the stopper 135 by moving it to a desired point along the length of the tether 25. In this way, a user may adjust the height of the pet toy 35 relative to a surface in order to accommodate smaller pets. When the pet toy 35 is pulled or tugged at by a pet, the pet extends the tether 25 from the housing 15, thereby rotating the biased reel in the second direction and unwinding the tether 25 from the biased reel. When the pet toy is let go by the pet, the biased reel automatically rotates in the second direction, thereby winding the tether 25 around the track and retracting the tether 25 into the housing 15. In this way, the pet toy apparatus 10 provides an interactive pet toy that does not require pet owner-pet interaction.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet toy apparatus, comprising:
a housing including an upper end, a lower end, a front side, a rear side, a sidewall interconnecting the first side to the second side, and an interior volume;
a bracket extending radially outwardly from the upper end, the bracket including an opening for removably mounting the bracket onto a structure;
an aperture disposed on the lower end, the aperture in communication with the interior volume of the housing;
a biased reel rotatably mounted into the interior volume of the housing, the biased reel configured to rotate in a first direction and an opposing second direction;
a tether wound about the biased reel, the tether including a first end affixed to the biased reel and a second end including a quick release mechanism configured to removably receive a toy;
wherein the tether is configured to wind and unwind about the biased reel;
wherein the biased reel is biased in the first direction;
wherein rotation of the biased reel in the first direction is configured to wind the tether around the biased reel and retract the tether into the interior volume of the housing;
wherein rotation of the biased reel in the second direction is configured to unwind the tether from the biased reel and extend the tether out of the interior volume of the housing;
wherein the tether is in communication with the aperture, such that the tether configured to be extended from and retracted into the interior volume of the housing through the aperture;
wherein the second end of the tether is positioned exterior to the housing;
a stopper slidably disposed about a longitudinal length of the tether, the stopper positioned between the second end of the tether and the aperture of the housing;
wherein the stopper is configured to stop retraction of the tether back into the housing.

2) The pet toy apparatus of claim 1, wherein the front side includes a front perimeter edge and the rear side includes a rear perimeter edge, wherein the sidewall interconnects the front perimeter edge to the rear perimeter edge, thereby defining the interior volume of the housing.

3) The pet toy apparatus of claim 2, wherein the sidewall is a circular sidewall and includes a planar surface extending annularly about the housing between the front and rear perimeter edges.

4) The pet toy apparatus of claim 1, wherein the front side includes a front surface including indicia.

5) The pet toy apparatus of claim 1, wherein the bracket comprises a U-shaped member including a first end and a second end affixed to the sidewall, an arcuate portion interconnecting the first end and the second end, and an opening configured to removably receive an item therethrough, thereby defining the opening of the bracket.

6) The pet toy apparatus of claim 2, wherein the aperture is disposed on the sidewall of the housing between the front and rear perimeter edges of the housing.

7) The pet toy apparatus of claim 1, wherein the biased reel includes a track defining a groove configured to receive and guide the tether when the tether is either extended into or retracted from the housing.

8) The pet toy apparatus of claim 1, wherein the quick release mechanism includes a female portion, a male portion, and a release collar, the female portion configured to removably engage the male portion, the release collar configured to disengage the female portion from the male portion.

9) The pet toy apparatus of claim 8, wherein the female portion includes an aperture configured to removably engage a pin disposed on the male portion, the release collar configured to disengage the aperture from the pin.

10) The pet toy apparatus of claim 8, further comprising a pet toy including a second tether having the male portion of the quick release mechanism.

11) The pet toy apparatus of claim 8, further comprising a plurality of pet toys each including a second tether having the male portion of the quick release mechanism.

12) The pet toy apparatus of claim 1, wherein the stopper extends annularly around the tether, the stopper including a diameter greater than a diameter of the aperture.
